(19) United States
(12) Patent Application Publication
(10) Pub. No.: US 2026/0050597 A1
(43) Pub. Date: Feb. 19, 2026

(54) INTERACTIVE SEARCH IN SECURITY ANALYTICS PLATFORM

(71) Applicant: Google LLC, Mountain View, CA (US)

(72) Inventors: Travis Lanham, Sunnyvale, CA (US); Abu Wawda, Cupertino, CA (US); David Slater, New York, NY (US); Michael Hom, Arlington, VA (US)

(21) Appl. No.: 19/298,861

(22) Filed: Aug. 13, 2025

Related U.S. Application Data
(60) Provisional application No. 63/682,921, filed on Aug. 14, 2024.

(51) Int. Cl. G06F 16/2455; H04L 9/40

(52) U.S. Cl. CPC G06F 16/24552; H04L 63/1425

(57) ABSTRACT

A system and method for performing interactive security search by a security analytics platform. An example method includes receiving, by one or more processing devices of a security analytics platform, a search request in a natural language; determining an intent of the search request and one or more search terms defining the search request; compiling a search query based on the intent of the search request and the one or more search terms defining the search request; determining whether the search query is cached in a search cache; responsive to determining that the search query is not cached in the search cache, extracting a plurality of security events by executing the search query against one or more data sources; storing the extracted security events in the search cache; generating a response to the search request by processing the plurality of security events; and returning the response.

### REFERENCE TO RELATED APPLICATION

This application claims the priority benefit of U.S. Provisional Patent Application No. 63/682,921, filed Aug. 14, 2024, the entirety of which is incorporated herein by reference.

### TECHNICAL FIELD

The present disclosure relates generally to cloud-based security analytics platforms. In particular, aspects and implementations of the present disclosure relate to implementing interactive search in a security analytics platform.

### BACKGROUND

In today's digital age, organizations are constantly facing an increasing volume of sophisticated cybersecurity threats. Cybersecurity is the practice of protecting systems, networks, and data from digital attacks, unauthorized access, and damage. Traditional cybersecurity measures are often inadequate in providing comprehensive protection against such threats, which has resulted in the proliferation of large numbers of disparate cybersecurity operations tools such as Security Orchestration, Automation, and Response (SOAR) platforms, Security Information and Event Management (SIEM) systems, Intrusion Detection Systems (IDS), Intrusion Prevention Systems (IPS), antivirus software, endpoint protection, vulnerability management tools, and more. These platforms and system can generate multiple alerts for each detection of a security threat. Because not all security threats are of equal importance, it can be challenging to sift through a large quantity of security threats. Analyzing and acting upon the staggering volume of security threats generated by such an ever-increasing number of cybersecurity operations tools is complex and cumbersome, leading to inefficiencies and vulnerabilities.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

A system and method are disclosed for performing interactive security search by a security analytics platform. In an implementation, a method includes receiving, by a security analytics platform, a search request in a natural language; determining an intent of the search request and one or more search terms defining the search request; compiling a search query based on the intent of the search request and the one or more search terms defining the search request; determining whether the search query is cached in a search cache; responsive to determining that the search query is not cached in the search cache, extracting a plurality of security events by executing the search query against one or more data sources; storing the extracted security events in the search cache; generating a response to the search request by processing the plurality of security events; and returning the response.

In some implementations, the plurality of security events includes a plurality of security events.

In some implementations, the one or more data sources include at least one of a log database or a telemetry data store.

In some implementations, storing the extracted security events in the search cache includes storing the extracted security events in association with a hash of the search query.

In some implementations, determining whether the search query is cached includes: computing the hash of the search query; and comparing the computed hash of the search query to each stored hash of a plurality of stored hashes, wherein each stored hash is associated with a corresponding cached set of security events extracted by a corresponding search query.

In some implementations, the search request further includes a time range, and wherein determining whether the search query is cached is further based on the time range.

In some implementations, generating the response further includes correlating the plurality of security events with threat intelligence data.

In some implementations, generating the response further includes correlating the plurality of security events with one or more anomaly detection signals.

In some implementations, generating the response further includes ranking the plurality of security events based on relevance.

In some implementations, returning the response includes streaming one or more partial results to a user interface while the response is being generated.

In some implementations, the response includes a distribution of event counts over a timeline.

An aspect of the disclosure provides a system including a memory device and a processing device communicatively coupled to the memory device. The processing device performs the method as described above.

An aspect of the disclosure provides a computer-readable storage medium (which can be a non-transitory computer-readable storage medium, although the disclosure is not limited to that) stores instructions which, when executed, cause a processing device to perform the method as described above.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example of a system architecture, in accordance with aspects of the disclosure.

FIG. 2 is an example illustration of a security taxonomy, in accordance with aspects of the disclosure.

FIG. 3 schematically illustrates a distributed memory object caching system implementing an M-ary tree data structure, in accordance with aspects of the present disclosure.

FIG. 4 is a high-level flow diagram of an example method 400 for implementing an interactive search in a security analytics platform operating in accordance with aspects of the present disclosure.

FIG. 5 is a block diagram illustrating an example of a computer system 1000, according to aspects of the disclosure.

### DETAILED DESCRIPTION

Aspects of the present disclosure relate to implementing interactive search in a security analytics platform. A security analytics platform can serve one or more clients (e.g., represented by entities such as organizations). The security analytics platform can provide a client organization with tools to manage computer and network security for the client.

The security analytics platform can be part of an online (e.g., virtual) platform that provides clients with a comprehensive suite of productivity tools, programs, and services. The security analytics platform can combine the features of a Security Information and Event Management (SIEM) system and a Security Orchestration, Automation, and Response (SOAR) system into a unified platform. The security analytics platform collects logs from a client and provides the client with tools to detect, analyze, and respond to incidents described in the collected logs. One or more features of the security analytics platform can be automated or partially automated, including log collection actions, incident detection actions, data analysis actions, or incident response actions.

The client organization can provide security data (e.g., ingested data) to the security analytics platform. As used herein, security data can include telemetry data such as log files produced by the operating systems, middleware, and/or applications that reflect actions which occurred at specific moments in time on a computing resource. Once the security analytics platform receives the ingested data from the client organization, the client organization can use the tools or services of the security analytics platform to perform security actions with the ingested data. The security actions of the security analytics platform can generate one or more of events, detections, or alerts from the ingested data. Some security analytics platforms can provide notifications based on the events, detections or alerts that are generated.

The security analytics platform can perform rule-based processing of security data. When a security rule is applied to security data, the security data is evaluated against a logical condition specified by the rule. If the security data satisfies the logical condition, the action specified by the security rule is performed, thus producing the outcome of the rule. Security rule outcomes can include a security signal (such an event, a detection (e.g., of a security threat), an alert (e.g., of a security threat)) and/or a corrective action to be performed (e.g., modification of a configuration of an entity referenced by the rule, such as a computer system).

“Security entity” or “entity” herein refers to an element belonging to or associated with a given computing environment (e.g., a computing environment of an organization served by the security analytics platform). Examples of entities include servers, computers, portable communication devices, networks, network addresses, infrastructure elements (such as switches, routers, firewalls, etc.), virtual machines, secure execution environments, applications, middleware, operating systems, hardware security modules, organizations, organizational units, individual users, etc.

In some implementations of security analytics platforms, queries can take tens of seconds or even minutes to execute. Besides, the user may only be allowed to see a limited number of events at a time, as the filters may be applied by the client device.

The security analytics platform implemented in accordance with aspects of the present disclosure enhances the functionality and improves the efficiency and speed of executing security data queries, as well as expands the size of the resultsets returned to the users.

In some implementations, the security analytics platform can perform a Unified Data Model (UDM)-based security data search. UDM-based search may be triggered by a search request in a natural language, which may be translated into one or more search queries having their search terms represented by UDM-compliant data items. A user, such as a programmable security agent, may utilize the UDM-based security data search functionality for querying and filtering security events, e.g., during threat hunting operations.

In some implementations, to support large query resultsets (e.g., two million or more events), the security analytics platform may perform event handling to a server and stream a sample of events, an event timeline, and filtering options to a client device. This may increase the size of the resultset to be analyzed by the user. To increase the query processing speed, the system may analyze incoming queries to determine if the queries can be fulfilled by one or more database indexes, which may reduce the time to receive initial results. Additionally, a cache, such as a distributed memory object caching system, may be used for fast retrieval of previously queried events. The system may also parallelize the application of snapshot filters, the calculation of an event count timeline, and the aggregation of Unified Data Model (UDM) fields.

In some implementations, an event cache can be implemented to support operations on large resultsets, thus improve performance for repeated queries, support aggregation of UDM fields and histograms, and support arbitrary pagination. Each cache entry can store a set of security events extracted by a previously executed query. Each cache entry may be identified by a hash of the search query that has extracted, from one or more security data sources (e.g., analytics databases, log files, etc.), the set of security events stored by that cache entry.

In some implementations, a bookkeeping database may be used to track metadata associated with ongoing queries and cached resultsets (e.g., sets of security events). The metadata can be organized into discrete Query Time Range (QTR) buckets for a given user and query.

In some implementations, the server may start responding to the search query by transmitting to the client small samples, such as 100 events per sample. Once the server determines it has identified a set of most recent events, for example 10,000 events, the server can send a “final” update of events to the client. Such a transmission of a “final” update does not necessarily indicate that the underlying query is complete. A separate indicator, such as a Boolean value, can be used to signal that the query has been completed. The response from the server can also indicate if a limit (e.g., a predefined maximum number of events) has been reached when fetching the baseline results.

At any point, the user interface can send a signal to stop a query. In response, the user interface may cease displaying further updates. The backend system, however, can continue to process events and populate a cache with the query results. Using a single streaming RPC can facilitate synchronization, as all four response types can reflect the same underlying data set at a given point in time. For example, the aggregated UDM fields and the event count timeline can be calculated over the same set of events, thus promoting data consistency.

In some implementations, a bookkeeping database may be used to track metadata associated with ongoing queries and cached resultsets (e.g., sets of security events). The metadata can be organized into discrete Query Time Range (QTR) buckets for a given user and query.

Thus, the security analytics platform implementing the methods described herein improves the functioning of distributed computing environments by improving the efficiency and speed of executing security data queries, as well as expanding the size of the resultsets returned to the users.

In particular, the distributed caching scheme improves the functioning of distributed computing environments by re-using the resultsets generated by previously executed queries, thus improving the efficiency and speed of executing security data queries. Furthermore, tracking metadata associated with ongoing queries and cached resultsets of previously executed queries improves the functioning of distributed computing environments by allowing more efficient reuse of the resultsets generated by previously executed queries. Furthermore, correlating the plurality of security events with threat intelligence data improves the functioning of distributed computing environments by providing most relevant threat hunting information to the user. Furthermore, correlating the plurality of security events with one or more anomaly detection signals improves the functioning of distributed computing environments by providing most relevant security-related information to the user. Furthermore, ranking the plurality of security events based on relevance improves the functioning of distributed computing environments by presenting most relevant security-related information to the user. Furthermore, streaming one or more partial results to a user interface while the response is being generated improves the functioning of distributed computing environments by reducing the latency of returning a full resultset in response to a search query. Furthermore, including a distribution of event counts over a timeline into the response generated by the security analytic platform improves the functioning of distributed computing environments by enhancing the presentation of the resultset to the user.

Various aspects of the methods and systems are described herein by way of examples, rather than by way of limitation. The systems and methods described herein may be implemented by hardware (e.g., general purpose and/or specialized processing devices, and/or other devices and associated circuitry), software (e.g., instructions executable by a processing device), or a combination thereof.

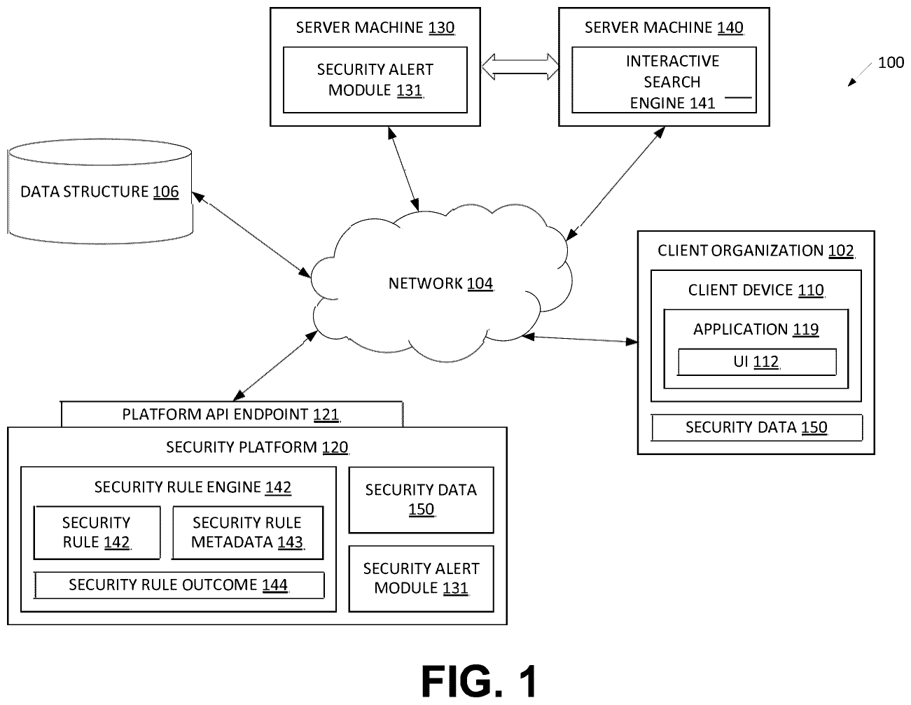

FIG. 1 illustrates an example of a system 100, in accordance with aspects of the disclosure. The system 100 includes a security analytics platform 120, one or more server machines 130-140, a data structure 106, and client organization 102 connected to network 104. In some implementations, system 100 can include one or more other platforms (not illustrated).

In some implementations, network 104 can include a public network (e.g., the Internet), a private network (e.g., a local area network (LAN) or wide area network (WAN)), a wired network (e.g., Ethernet network), a wireless network (e.g., an 702.11 network or a wireless fidelity (Wi-Fi) network), a cellular network (e.g., a Long Term Evolution (LTE) network), routers, hubs, switches, server computers, and/or a combination thereof.

Data structure 106 can be a persistent storage that is capable of storing data such as log information (e.g., sequences of characters in a log), labels reflecting a type of log, and the like. Data structure 106 can be hosted by one or more storage devices, such as main memory, magnetic or optical storage based disks, tapes or hard drives, network-attached storage (NAS), storage area network (SAN), and so forth. In some implementations, data structure 106 can be a network-attached file server, while in other implementations the data structure 106 can be another type of persistent storage such as an object-oriented database, a relational database, and so forth, that can be hosted by security analytics platform 120, or one or more different machines coupled to the server hosting the security analytics platform 120 via the network 104. In some implementations, data structure 106 can be capable of storing one or more data items, as well as data structures to tag, organize, and index the data items. A data item can include various types of data including structured data, unstructured data, vectorized data, etc., or types of digital files, including text data, audio data, image data, video data, multimedia, interactive media, data objects, and/or any suitable type of digital resource, among other types of data. An example of a data item can include a file, database record, database entry, programming code or document, among others.

The client organization 102 can include one or more client device(s) (e.g., client device 110). Each client device 110 can include a type of computing device such as a desktop personal computer (PCs), laptop computer, mobile phone, tablet computer, netbook computer, wearable device (e.g., smart watch, smart glasses, etc.) network-connected television, smart appliance (e.g., video doorbell), any type of mobile device, etc. In some implementations, client devices 110 can be one or more computing devices (such as a rackmount server, a router computer, a server computer, a personal computer, a mainframe computer, a laptop computer, a tablet computer, a desktop computer, etc.), data structures (e.g., hard disks, memories, databases), networks, software components, or hardware components. In some implementations, client device(s) may also be referred to as a “user device” herein. Although a single client device 110 is shown for purposes of illustration rather than limitation, one or more client devices can be implemented in some implementations. Client device 110 will be referred to as client device 110 or client devices 110 interchangeably herein.

In some implementations, a client device, such as client device 110, can implement or include one or more applications. In some implementations, application 119 can be used to communicate (e.g., send and receive information) with the security analytics platform 120. In some implementations, application 119 can implement user interfaces (Uis) (e.g., graphical user interfaces (GUis)), such as a user interface (UI) (e.g., UI 112) that may be webpages rendered by a web browser and displayed on the client device 110 in a web browser window. In another implementation, the Uis 112 of client application, such as application 119 may be included in a stand-alone application downloaded to the client device 110 and natively running on the client device 110 (also referred to as a “native application” or “native client application” herein). In some implementations, interactive search engine 141 can be implemented as part of application 119. In other implementations, interactive search engine 141 can be separate from application 119 and application 119 can interface with interactive search engine 141.

In some implementations, one or more client devices 110 can be connected to the system 100. In some implementations, client devices, under direction of the security analytics platform 120 when connected, can present (e.g., display) a UI 112 to a user of a respective client device through application 119. The client devices 110 may also collect input from users through input features.

In some implementations, a UI 112 may include various visual elements (e.g., UI elements) and regions, and can be a mechanism by which the user engages with the security analytics platform 120, and system 100 at large. In some implementations, the UI 112 of a client device 110 can include multiple visual elements and regions that enable presentation of information, for decision-making, content delivery, etc. at a client device 110. In some implementations, the UI 112 may sometimes be referred to as a graphical user interface (GUI)).

In some implementations, the UI 112 and/or client device 110 can include input features to intake information from a client device 110. In one or more examples, a user of client device 110 can provide input data (e.g., a user query, control commands, etc.) into an input feature of the UI 112 or client device 110, for transmission to the security analytics platform 120, and system 100 at large. Input features of UI 112 and/or client device 110 can include space, regions, or elements of the UI 112 that accept user inputs. For example, input features may include visual elements (e.g., GUI elements) such as buttons, text-entry spaces, selection lists, drop-down lists, etc. For example, in some implementations, input features may include a chat box which a user of client device 110 can use to input textual data (e.g., a user query). The application 119 via client device 110 can then transmit that textual data to security analytics platform 120, and the system 100 at large, for further processing. In other examples, input features can include a selection list, in which a user of client device 110 can input selection data e.g., by selecting, or clicking. The application 119 via client device 110 can then transmit that selection data to security analytics platform 120, and the system 100 at large, for further processing.

In some implementations, a client device 110 can access the security analytics platform 120 through network 104 using one or more application programming interface (API) calls via platform API endpoint 121. In some implementations, security analytics platform 120 can include multiple platform API endpoints 121 that can expose services, functionality, or information of the security analytics platform 120 to one or more client devices 110. In some implementations, a platform API endpoint 121 can be one end of a communication channel, where the other end can be another system, such as a client device 110 associated with a user account. In some implementations, the platform API endpoint 121 can include or be accessed using a resource locator, such a universal resource identifier (URI), universal resource locator (URL), of a server or service. The platform API endpoint 121 can receive requests from other systems, and in some cases, return a response with information responsive to the request. In some implementations, HTTP (Hypertext Transfer Protocol), HTTPS (Hypertext Transfer Protocol Secure) methods (e.g., API calls) can be used to communicate to and from the platform API endpoint 121.

In some implementations, the platform API endpoint 121 can function as a computer interface through which access requests are received and/or created. In some implementations, the platform API endpoint 121 can include a platform API whereby external entities or systems can request access to services and/or information provided by the security analytics platform 120. The platform API can be used to programmatically obtain services and/or information associated with a request for services and/or information.

In some implementations, the API of the platform API endpoint 121 can be any suitable type of API such as a REST (Representational State Transfer) API, a GraphQL API, a SOAP (Simple Object Access Protocol) API, and/or any suitable type of APL In some implementations, the security analytics platform 120 can expose through the API, a set of API resources which when addressed can be used for requesting different actions, inspecting state or data, and/or otherwise interacting with the security analytics platform 120. In some implementations, a REST API and/or another type of API can work according to an application layer request and response model. An application layer request and response model can use HTTP, HTTPS, SPDY, or any suitable application layer protocol. Herein HTTP-based protocol is described for purposes of illustration, rather than limitation. The disclosure should not be interpreted as being limited to the HTTP protocol. HTTP requests (or any suitable request communication) to the security analytics platform 120 can observe the principals of a RESTful design or the protocol of the type of APL RESTful is understood in this document to describe a Representational State Transfer architecture. The RESTful HTTP requests can be stateless, thus each message communicated contains all necessary information for processing the request and generating a response. The platform API can include various resources, which act as endpoints that can specify requested information or requesting particular actions. The resources can be expressed as URI's or resource paths. The RESTful API resources can additionally be responsive to different types of HTTP methods such as GET, PUT, POST and/or DELETE.

In some implementations, any element, such as server machine 130, server machine 140, and/or data structure 106 may include a corresponding API endpoint for communicating with APis.

In some implementations, the security analytics platform 120 may include one or more computing devices (such as a rackmount server, a router computer, a server computer, a personal computer, a mainframe computer, a laptop computer, a tablet computer, a desktop computer, etc.), data structures (e.g., hard disks, memories, databases), networks, software components, or hardware components that can be used to provide a user with access to data or services. Such computing devices can be positioned in a single location or can be distributed among many different geographical locations. For example, security analytics platform 120 can include a plurality of computing devices that together may comprise a hosted computing resource, a grid computing resource, or any other distributed computing arrangement. In some implementations, the security analytics platform 120 can correspond to an elastic computing resource where the allotted capacity of processing, network, storage, or other computing-related resources may vary over time.

In some implementations, the security analytics platform 120 can implement one or more techniques to collect, analyze, and respond to security data 150 received from a client organization 102. The security analytics platform can collect the security data 150 from the client organization 102. In some implementations, the security analytics platform 120 includes one or more security data ingestion points. In some implementations, one or more aspects of the collection of the security data 150 the client organization 102 are automated or partially automated. In some implementations, the security data 150 can be stored in the data structure 106. The security analytics platform 120 can provide the client organization 102 with tools to analyze the security data 150.

Security data 150 can be generated by the client organization 102 and can include information describing activities in a computing environment of the client organization 102 (e.g., including client device 110, application 119, etc.). In some implementations, the security data 150 includes details about the activity that the client organization 102 can use to analyze the activity, respond to an event, or implement policies to avoid, or promote similar activity in the future. In some implementations, tools, applications, or systems of or used by the client organization 102 can generate security data 150. In some implementations, the security analytics platform 120 can receive security data 150 generated by a client organization 102. For example, and in some implementations, the client organization 102 can provide the security analytics platform 120 with security data 150 as an automated or semi-automated process. In some implementations, the security data 150 are received one at a time. In some implementations, the security data 150 is received as a list, group, table, or other data structure. In some implementations, one or more of security data 150 are received discreetly (e.g., at specific times). In some implementations, the security data 150 are received as a real-time data stream.

In some implementations, the security data 150 includes one or more entries, such as temporal data (e.g., a timestamp), an event description, network data (e.g., internet protocol (IP) address(es), network traffic data, or network configuration data), a user identification, system information (e.g., a computing environment of the client), security context information, or the like. In some implementations, the security data 150 includes information related to the client organization 102. For example, security data 150 from Organization A using Application X can include Organization A information and Application X information, while security data from Organization B using Application X may only include Application X information. In some implementations, the security data 150 can include organization-specific data. In some implementations, a portion of the security data 150 for logs received from different organizations (e.g., client organization 102) can be the same or similar.

In some implementations, the security data can be labeled or tagged to allow, e.g., efficient correlation of various data items that may be related to a common set of entities and/or may share a common set of parameters. In some implementations, one or more aspects of the tools to analyze the information extracted from the security data 150 can be automated or partially automated. The security analytics platform 120 can provide the client organization 102 with tools to perform one or more security actions based on information extracted from the security data 150 received from the client organization 102. In some implementations, the security analytics platform 120 can allow the client organization 102 to configure certain security response parameters related to performing one or more actions based on information extracted from the security data 150. For example, the security analytics platform 120 can allow the client to indicate a particular security action that is to be triggered when a security rule produces an outcome. In some implementations, one or more aspects of the tools to perform one or more actions based on the information extracted from the security data 150 can be automated or partially automated.

The security analytics platform 120 can implement a security rule engine 142. The security rule engine can implement one or more features and/or operations as described herein. In some implementations, security rule engine can include or access an artificial intelligence (AI) model (e.g., a machine learning model) to perform the one or more features and/or operations (not illustrated). In some implementations, the security analytics platform 120 receives security data 150 from the client organization 102. Security data 150 can include data that pertains to security data (e.g., security logs) received from the client organization 102. The security rule engine can process the security data 150 to obtain a security rule outcome 144. In some implementations, the security rule engine can process additional inputs, including security rule metadata 143, and security rule outcomes 144 from previously performed security rules 142. The security rule engine can include or interface with a GUI (e.g., UI 112) to provide users of a client device 110 of a client organization 102 with a user interface to configure one or more parameters of the security rule engine. For example, the UI 112 can be used to define one or more security rules. In some implementations, security rule metadata 143 can include one or more of data type identifiers, data labels, a source of the security data 150, or the like.

The security analytics platform 120 can feed the security data 150 to a security rule engine (e.g., security rule engine). In some implementations, the security rule engine applies one or more of the security rules 142 to one or more subsets of the ingested security data. In some implementations, the client organization 102 configures parameters of the security analytics platform 120 based on one or more security rules. Each security rule can be configured individually, e.g., via manipulating visual objects and controls rendered by a graphical user interface and/or creating or editing formal rule definitions in a predefined scripting language. Once a rule is configured, it can automatically be applied to the ingested data.

In an illustrative example, the security rule engine can provide an outcome from a security rule to the security alert module 131 of the security analytics platform 120. In some implementations, the security alert module 131 can generate a notification for a specified outcome of the security rule.

In some implementations, the security rule engine (e.g., via the security analytics platform 120) can generate, modify, and monitor the client-side Uis (e.g., graphical user interfaces (GUI)) and associated components that are presented to users of the security analytics platform 120 through UI 112 client devices 110. For example, security rule engine can generate the Uis (e.g., UI 112 of client device 110) that users interact with while engaging with the security analytics platform 120.

In some implementations, a machine learning model (e.g., also referred to as an “artificial intelligence (AI) model” herein) can include a discriminative machine learning model (also referred to as “discriminative AI model” herein), a generative machine learning model (also referred to as “generative AI model” herein), and/or other machine learning model.

In some implementations, a discriminative machine learning model can model a conditional probability of an output for given input(s). A discriminative machine learning model can learn the boundaries between different classes of data to make predictions on new data. In some implementations, a discriminative machine learning model can include a classification model that is designed for classification tasks, such as learning decision boundaries between different classes of data and classifying input data into a particular classification. Examples of discriminative machine learning models include, but are not limited to, support vector machines (SVM) and neural networks.

In some implementations, a generative machine learning model learns how the input training data is generated and can generate new data (e.g., original data). A generative machine learning model can model the probability distribution (e.g., joint probability distribution) of a dataset and generate new samples that often resemble the training data. Generative machine learning models can be used for tasks involving image generation, text generation and/or data syn-thesis. Generative machine learning models include, but are not limited to, gaussian mixture models (GMMs), variational autoencoders (VAEs), generative adversarial networks (GANs), large language models (LLMs), vision-language models (VLMs), multi-modal models (e.g., text, images, video, audio, depth, physiological signals, etc.), and so forth.

In some implementations, server machine 130 and server machine 140 can be one or more computing devices (such as a rackmount server, a router computer, a server computer, a personal computer, a mainframe computer, a laptop computer, a tablet computer, a desktop computer, etc.), data structures (e.g., hard disks, memories, databases), networks, software components, or hardware components that can be used to provide a user with access to one or more data items of the security analytics platform 120. The security analytics platform 120 can also include a website (e.g., a webpage) or application back-end software that can be used to provide users with access to the security analytics platform 120.

In some implementations, one or more of the server machine 130 or the server machine 140 can be part of the security analytics platform 120. In other implementations, one or more of the server machine 130 or the server machine 140 can be separate from security analytics platform 120 (e.g., provided by a third-party service provider).

In some implementations, the security analytics platform can implement the interactive search engine 141 which provides a user (e.g., a security analyst or a system administrator) of the client organization with a user interface to access and use the tools and functionality of the security analytics platform. In some implementations, the user interface may be implemented by a graphical user interface (GUI). In some implementations, the user interface may be implemented by an application programming interface (API).

The user interface may provide interactive search capabilities over the enterprise security data. In an illustrative example, a user may issue a natural language search request that may include natural language words, numbers, alphanumeric identifiers of various entities, etc. (e.g., “list all hosts on my network that connected to IP addresses that most of the other hosts never connect”). The security analytics platform may analyze the natural language search request to extract the intent and search terms and compile a query (in a formal language) that reflects the intent and utilizes the search terms.

In some implementations, the security analytics platform may then determine whether the query is cached in the search cache (e.g., by a distributed memory object caching system). Such a determination may involve computing a hash of the query and attempting to find a matching hash among a set of stored hashes. Each stored hash may be associated with a cache entry that stores a set of security events that have been previously extracted from one or more data sources by executing a search query whose hash acts as an identifier of the cache entry. “Hash” herein refers to a one-way mathematical function that transforms an arbitrary input (e.g., sequence of bytes) into an output bit sequence of a predefined size.

Responsive to identifying a matching hash among a set of stored hashes, the security analytics platform may retrieve the cached security events. Conversely, responsive to failing to identify a matching hash among a set of stored hashes, the security analytics platform may execute the query against one or more data sources, thus extracting relevant data items (e.g., security events), which may then optionally be filtered (e.g., by the data range, IP addresses, alert severity levels, etc.). The extracted and filtered data items may then be stored, in association with a hash the search query, in the search cache.

In some implementations, the security analytics platform may correlate the security events with threat intelligence data, which may, e.g., specify the degree of association of various security-related entities (e.g., hosts, IP addresses, software modules, etc.) with known security threats.

In some implementations, the security analytics platform may correlate the security events with various anomaly detection signals (e.g., a particular host connected to a remote host in a domain that has not been visited by other hosts on the enterprise net work).

The security analytics platform may then rank the results, e.g., by relevance, and return the results (e.g., via the GUI or the API that was used for submitting the search request). In some implementations, the security analytics platform may store the results in an interactive search cache thus facilitating efficient processing of likely follow-up search requests that may, e.g., apply additional filters to the resultset, drill down into certain results, etc.

In general, functions described in implementations as being performed by security analytics platform 120, client organization 102, and/or server machine 140 can also be performed on the client device 110 in other implementations, if appropriate. In addition, the functionality attributed to a specific component can be performed by different or multiple components operating together. The security analytics platform 120 can also be accessed as a service provided to other systems or devices through appropriate application programming interfaces, and thus is not limited to use in websites.

In implementations of the disclosure, a “user” can be represented as a single individual. For example, a user of the client device 110. However, other implementations of the disclosure encompass a “user” being an entity controlled by a set of users and/or an automated source (e.g., client organization 102). For example, a set of individual users federated as a community in a social network can be considered a “user.” In another example, an automated consumer can be an automated ingestion pipeline of security analytics platform 120.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a specific location of a user cannot be determined. Thus, the user can have control over what information is collected about the user, how that information is used, and what information is provided to the user.

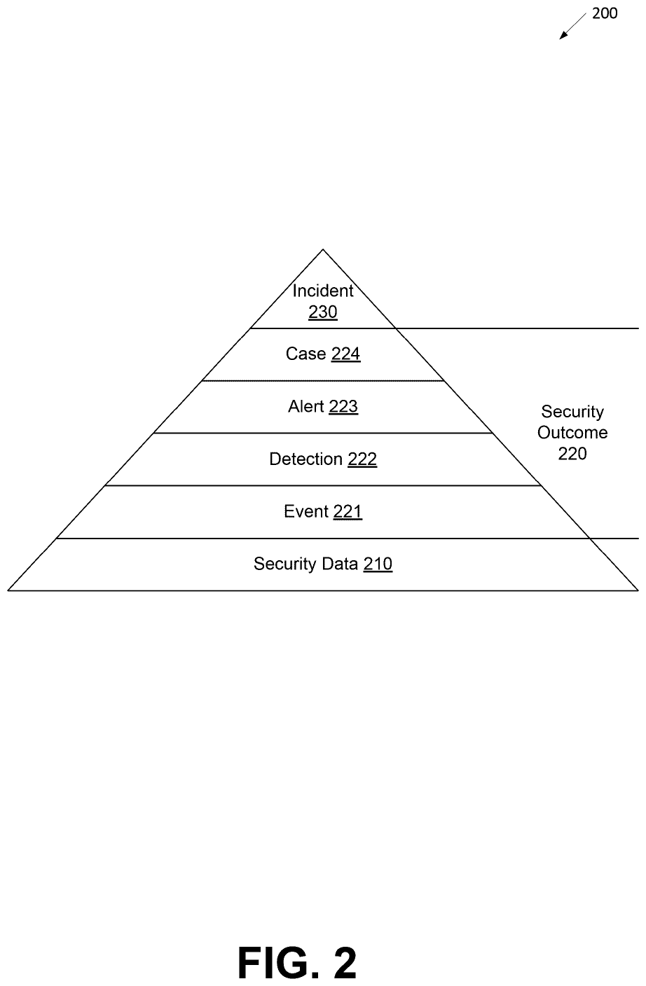

FIG. 2 is an example illustration of a security taxonomy 200, in accordance with aspects of the disclosure. Security taxonomy 200 includes security data 210, event 221, detection 222, alert 223, case 224, and incidents 230. As used herein, security outcome 220 can include one or more of an event 221, a detection 222, an alert 223, or a case 224. Generally, incidents 230 can refer to any of one or more of an event 221, a detection 222, an alert 223, or a case 224 that exceeds a threat-level threshold condition, as defined by the security analytics platform and/or an organization using the security analytics platform. In some implementations, security outcome 220 can include incidents 230. It can be appreciated that the security taxonomy 200 is included herein to define, and provide examples of “security outcomes” (e.g., security outcome 220), which is meant to be an inclusive representation and definition, rather than an exclusive representation and definition.

Security data 210 can include all data generated by an organization (e.g., client organization 102) that is sent to a security analytics platform (e.g., security analytics platform 120) for processing (e.g., ingested data). As described above, security data 210 can include telemetry data. The security analytics platform can process the security data 210 using one or more security rules. As described above, a security rule is a defined set of criteria and instructions used to process the security data (and/or outcomes from other security rules).

Security data 210 can be processed by a security rule into a security outcome 220, which can include one or more of an event 221, a detection 222, an alert 223, or a case 224. In some implementations, once security data 210 is processed by a security rule, the resulting data is a security outcome 220 (e.g., one of an event 221, a detection 222, an alert 223, or a case 224), or an incident 230.

The security analytics platform can process the event 221 using one or more security rules. An event 221, which is an indication of a noticeable change in the state of a computing system, can be derived from security data 210, which may include one or more data items produced by the computing system or characterizing the computing system. In some implementations, an additional context or significance associated with the event can be represented by a label or tag attached to the event. In some implementations, the additional context or significance can be added as metadata to the security data (e.g., security data 210) to generate the event 221. In some implementations, multiple sets of security data 210 can be processed by a single security rule to generate an event 221. An event 221 can be processed by a security rule into another security outcome 220, including one or more security events (e.g., event 221), a detection 222, an alert 223, or a case 224. In some implementations, the event 221 can be processed into an incident 230.

The security analytics platform can process the detection 222 using one or more security rules. A detection 222 can refer to an object that is generated from matched or correlated security events (e.g., event 221) that pertains to an indication, or potential indication of a security threat. A detection 222 can include an analytical assessment of an event 221, and/or security data 210. In some implementations, data used to generate the detection 222 (e.g., security data 210, event 221, another detection, etc.) can be matched or correlated by an algorithm or machine learning model. In some implementations, the detection 222 can be generated from a security rule based on security data 210. In some implementations, the detection 222 can be generated from a security rule based on event 221 and security data 210. Detection 222 can be processed by a security rule into another security outcome 220, including one or more of another security detection (e.g., a detection 222), an alert 223 or a case 224. In some implementations, detection 222 can be processed into an incident 230.

The security analytics platform can process the alert 223 using one or more security rules. An alert 223 can refer to a security outcome 220 that satisfies an alert threshold criterion. An alert 223 can be a detection 222 that satisfies the alert threshold criterion. In some implementations, the security outcome 220 can satisfy an alert threshold based on one or more characteristics of the security outcome 220. Characteristics of security outcomes 220 can be reflected in metadata associated with the security outcome 220. In some implementations, a security rule can process one or more of security data 210, an event 221, a detection 222, or other alert 223 to determine whether the processed data satisfies the alert threshold. An alert 223 can be processed by a security rule into another security outcome 220, including one or more of another security alert (e.g., an alert 223) or a case 224. In some implementations, the alert 223 can be processed into an incident 230.

The security analytics platform can process the case 224 using one or more security rules. A security case (e.g., case 224) can refer to a collection of one or more security alerts (e.g., alert 223), detections (e.g., detection 222), events (e.g., event 221), and/or security data 210 that have one or more of the same or similar characteristics (e.g., metadata). In some implementations, case 224 can be grouped based on temporal characteristics. For example, security outcomes 220 and security data 210 can be grouped into case 224 based on an access time, or processing time associated with the security outcomes 220 or security data 210. Case 224 can be processed by a security rule into another security outcome 220 such as another security case (e.g., case 224). In some implementations, the case 224 can be processed into an incident 230.

The security analytics platform can process an incident 230 based on one or more security rules. An incident 230 can refer to a security outcome 220 that meets one or more criteria for investigation. In some implementations, the investigation that is triggered for the incident 230 can be a manual investigation by security researchers. In some implementations, the investigation that is triggered for the incident 230 can be an automated or semi-automated investigation using one or more of security investigation algorithms, artificial intelligence (AI) models, or the like.

As described herein with reference to FIG. 2, a security outcome 220 can include one or more of an event 221, a detection 222, an alert 223, or a case 224. In some implementations, a security outcome 220 can include an incident 230. Security outcomes 220 can be generated by one or more security rules that process one or more of security data 210, an event 221, a detection 222, an alert 223, or a case 224. For example, a security rule can process the security data 210, a detection 222, and an alert 223 to generate a security outcome 220. In another example, a security rule can process a detection 222 to generate a security outcome 220. In another example, a security rule can process the security data 210 to generate a security outcome 220. In some implementations, security outcomes 220 can be generated by security rules that additionally process data from an incident 230. For example, a security outcome 220 (e.g., a security detection) can be obtained by processing the security data 210 and a detection 222 on a security analytics platform using a security rule. In another example, a security outcome 220 (e.g., a security event) can be obtained by processing the security data 210 and an event 221. In another example, a security outcome 220 (e.g., a security alert) can be obtained by processing the event 221, the detection 222, and the alert 223. Thus, it can be appreciated that security rules can operate on security data 210 and any of security outcomes 220 to produce another security outcome 220. In some implementations, security outcomes 220 of a lower tier on the security taxonomy 200 are processed by a security rule to generate security outcomes 220 of the same, or a higher tier. For example, event 221 and detection 222 can be processed by a security rule to generate additional detection 222, or alert 223.

As noted herein above, a method for security data search implemented in accordance of aspects of the present disclosure may enhance the functionality and improve the performance of security data queries, as well as expand the size of the resultset.

In some implementations, the security analytics platform can perform a Unified Data Model (UDM)-based security data search. UDM-based search may be triggered by a search request in a natural language, which may be translated into one or more search queries having their search terms represented by UDM-compliant data items. A user, such as a programmable security agent, may utilize the UDM-based security data search functionality for querying and filtering security events, e.g., during threat hunting operations.

In some implementations, to support large query resultsets (e.g., two million or more events), the security analytics platform may perform event handling by a server and stream a sample of events, an event timeline, and filtering options to a client device. This may increase the size of the resultset to be analyzed by the user. To increase the query processing speed, the system may analyze incoming queries to determine if the queries can be fulfilled by one or more database indexes, which may reduce the time to receive initial results. Additionally, a cache, such as a distributed memory object caching system, may be used for fast retrieval of previously queried events. The system may also parallelize the application of snapshot filters, the calculation of an event count timeline, and the aggregation of Unified Data Model (UDM) fields.

In some implementations, ingested security events from one or more data sources (e.g., security databases, log files, etc.) can be normalized and written to a temporary storage. Each normalized event can be enriched with additional context, e.g., by a separate worker thread, and written back to the analytics database.

In some implementations, a query manager module may be implemented by the server to analyze a query. For example, the query manager can identify one or more particular data sources against which the query can be executed (e.g., based on the UDM fields contained by or derived from the query). The query manager may further manage parallelized reads from the identified one or more data sources.

To manage potential query incast issues, which can manifest themselves as performance bottlenecks occurring when multiple clients simultaneously send data to a single server, a query can be divided into multiple sub-queries corresponding to different time ranges. These sub-queries can be assigned to respective sub-tasks, which can be executed by separate worker threads. A sub-task can, for example, accept rows from a data source, calculate partial histograms for a set of results, calculate partial aggregated UDM fields for the set of results, write content nodes for the set of results to a cache, and transmit the partial histogram, partial UDM fields, and content node keys to a root task for coordination.

A server of the security analytics platform can query for the events from one or more identified data source (e.g., analytics databases, log files, etc.), and write the events to a cache. A time-to-live (TTL) for the event in the cache instance can be variable, for example, approximately 15 minutes for recent events and on the order of hours for older events. Entries in the cache can be located in customer-specific namespaces, and older events may be purged to free up space.

To organize cached information, one approach involves associating the cached information with a specific user session, such as a browser session. A session token can be transmitted to the client when a query is first initiated. The token can be attached to subsequent actions, which allows the system to locate cached values corresponding to the user session. This configuration can simplify data organization, as events for an initial query may be readily discoverable. The cached events may be transformed in various ways, as the cached events are accessed by a single browser session.

Another approach for organizing cached information is based on the query itself. For a given query, the system may search for previously cached queries that are identical or more general. For example, a cached result for a query “A AND B” could be used by the server to fulfill a new query “A AND B AND C”. This may result in an increased number of cache hits. However, if the more general query was subject to a processing limit (e.g., two million events), leveraging the cache for the more specific query may yield artificially limited results. For example, in a case where terms “A” and “B” are common but term “C” is rare, using the cache from the general query could return zero results because the system did not query an underlying data source for the more specific query. In some implementations, this approach may be used if the more general query was not subject to a processing limit.

Events stored in the cache can have variable time-to-live (TTL) values. For example, events that have occurred recently may have a TTL between 15 and 30 minutes, while older events can have a longer TTL, such as in the order of hours.

In some implementations, the user interface can use a single streaming remote procedure call (RPC) for the search functionality. The RPC can specify a snapshot query and options for various user interface components, such as options for an event list, options for an event count timeline, and options for Unified Data Model (UDM) field aggregation.

In response to the RPC, a server of the security analytics platform can stream several types of data back to the user interface on a client device. For example, the server can stream progress indicators, a list of events for displaying, an event count timeline (e.g., an array of time buckets and a corresponding numbers of events per bucket), and aggregated UDM fields (e.g., an array of UDM fields and their values that can be used for filtering).

In some implementations, the server can determine a bucket size for generating the even count timeline, e.g., based on the time range of the query. For example, for the query time range of less than 30 minutes, the bucket resolution of one minute may be used. In another example, for the query time range between 16 and 30 days, the bucket resolution of 24 hours may be used. The server can periodically send a status of every bucket, which can reduce the need for the UI to apply deltas. Updates to the timeline can include a count of events in the baseline results.

In some implementations, low granularity progress indicators may be sufficient. Since a query may be broken up into fine-grained time buckets, the progress reporting can be relatively accurate.

In some implementations, the server can send a plurality of UDM fields to the UI to be presented as selectable filters. In scenarios where an increase in a resultset limit could lead to a large number of fields or fields with a large number of values, a subset of the available filters may be identified for forwarding to the client. To handle filters with a large number of values, the system may send the most and least popular values. In some implementations, functionality can be provided to search for values that were not initially transmitted to the UI. Certain UDM fields that may be ignored by the UI when building filters can also be identified and their behavior replicated by the server.

Responses from the server can contain values for one or multiple of predefined data types (e.g., a progress indicator characterizing the progress of the query execution, a list of events extracted by the query, an event count timeline of the extracted events, and/or aggregated UDM fields for filtering the extracted events). In some implementations, for each of these data types, the server transmits the entire payload of information that the user interface can display. For example, if a list of events to be displayed is updated from a first set of events [A] to a second set of events [A, B], the server transmits the entire second set [A, B]. This approach can reduce processing on the client device by avoiding the need for diffing logic to determine changes between payloads.

In some implementations, the server may start responding to the search query by transmitting to the client small samples, such as 100 events per sample. Once the server determines it has identified a set of most recent events, for example 10,000 events, the server can send a “final” update of events to the client. Such a transmission of a “final” update does not necessarily indicate that the underlying query is complete. A separate indicator, such as a Boolean value, can be used to signal that the query has been completed. The response from the server can also indicate if a limit (e.g., a predefined maximum number of events) has been reached when fetching the baseline results.

At any point, the user interface can send a signal to stop a query. In response, the user interface may cease displaying further updates. The backend system, however, can continue to process events and populate a cache with the query results. Using a single streaming RPC can facilitate synchronization, as all four response types can reflect the same underlying data set at a given point in time. For example, the aggregated UDM fields and the event count timeline can be calculated over the same set of events, thus promoting data consistency.

In some implementations, responsive to receiving a search query, the security analytics platform may determine whether the query is cached in the search cache. Such a determination may involve computing a hash of the query and attempting to find a matching hash among a set of stored hashes.

In some implementations, an event cache can be implemented to support operations on large resultsets, thus improve performance for repeated queries, support aggregation of UDM fields and histograms, and support arbitrary pagination. Each cache entry can store a set of security events extracted by a previously executed query. Each cache entry may be identified by a hash of the search query that has extracted, from one or more security data sources (e.g., analytics databases, log files, etc.), the set of security events stored by that cache entry.

This caching scheme may allow multiple users (e.g., programmable security agents) leverage the same resultset. In some implementations, the cache is leveraged only if a query and a time range are identical to a previously executed query. This approach can reduce the risk of returning artificially limited results, for example, when a general query was previously cached and a more specific query is being executed later.

To facilitate cache reuse within a single user session where filters are progressively applied, a baseline query may be maintained separately from a snapshot filter. For example, if a user first queries for “A AND B” and then adds a filter to exclude “C” (where A, B, and C are the search terms represented, e.g., by UDM data items), the user can transmit a remote procedure call (RPC) that maintains “A AND B” as the baseline query, independent of the snapshot filter for “NOT C”. In some implementations, if the user interface transmits the search query “A AND B AND NOT C,” the server may identify the resultset of the previously executed query “A AND B,” retrieve the resultset from the cache, and apply the filter “NOT C” to the retrieved results set. This approach may result in an increased number of cache hits. However, if the more general query was subject to a processing limit (e.g., two million events), leveraging the cache for the more specific query may yield artificially limited results. For example, in a case where terms “A” and “B” are common but term “C” is rare, using the cache from the general query could return zero results because the system did not query an underlying data source for the more specific query. In some implementations, this approach may be used if the more general query is not subject to a processing limit.

In some implementations, baseline and snapshot queries can support multiple UDM field types, such as integers, strings, and enumerations. Supported queries may also include logical operators (e.g., AND, NOT, OR), regular expressions on string fields (both case sensitive and case insensitive), and case-insensitive string matches on string fields.

In some implementations, various metrics regarding cache misses can be collected to determine potential performance improvements from more liberal cache usage strategies, such as reusing cached data for the same query with a different time range or using a cached result from a more general query to fulfill a more specific one.

In some implementations, a bookkeeping database may be used to track metadata associated with ongoing queries and cached resultsets (e.g., sets of security events). The metadata can be organized into discrete Query Time Range (QTR) buckets for a given user and query.

For example, QTR buckets could represent five-minute intervals. A query for a one-hour time range, such as 12:30 to 1:30, would correspond to data in twelve separate five-minute QTR buckets. If a subsequent query requests data for a partially overlapping time range, such as 1:00 to 2:00, the system can reuse the already cached QTR buckets (e.g., for 1:00 to 1:30) and only fetch the new data (e.g., for 1:30 to 2:00). Each QTR bucket may correspond to multiple rows in a bookkeeping table, where each row represents a content node containing a set of events.

To simplify interactions between the server and the cache, reads to a database layer may be aligned within a single Query Time Range (QTR) bucket. For example, a single worker task may be responsible for fetching all events in a particular QTR bucket, committing the fetched events to a cache, and writing corresponding keys to the bookkeeping database.

A challenge can arise in respecting event limits for queries that do not align with predefined QTR bucket boundaries. For example, if a large number of events occur at 2:01, and a user queries for a time range of 2:02 to 3:00, simply rounding the query to the nearest QTR bucket (e.g., 2:00 to 2:05) could exclude relevant data. To address this, queries to populate a QTR bucket can be issued separately from the query specified by the user. For instance, for a user query from 2:02 to 3:00, two separate queries may be issued to the data source: one for the range 2:00 to 2:02 and another for the range 2:02 to 3:00. This approach allows for separate event limits to be applied to the user-specified time range, ensuring the user receives the data of interest, while also allowing for the stitching of results to populate content nodes and bookkeeping rows in the cache.

To manage multiple time ranges, the server can determine whether a given QTR bucket for a specified query is fully cached, partially cached, or needs to be fetched from a data source. In some implementations, the system can be designed to be resilient to portions of the cache expiring. In some implementations, to reduce complexity, a time range can be included in a hash of a query, and QTR buckets may not be reused across different time-range queries.

In some implementations, the bookkeeping database may be utilized to organize events based on their respective timestamps, thus facilitating future time-range stitching of query results. However, certain database consistency models can affect performance in some use cases. For example, a system with multiple workers may be concurrently ingesting events, calculating aggregated UDM fields, and streaming results to a client. If a user subsequently applies a filter, a subsequent read from the database may need to incorporate the content being concurrently written to avoid missing data. Relying on a database snapshot could result in returning an incomplete data set. Addressing this scenario could involve a series of higher-latency, strongly consistent reads or re-querying for data blocks that are already present in a cache.

In some implementations, when a user applies one or more filters presented in a user interface, the server can apply those filters to a cached or newly extracted set of baseline security events. The server can then calculate new aggregated UDM fields and a new event count timeline based on the filtered set of events and transmit the updated values to the user interface for display. To reduce latency associated with applying filters on the server over a large set of events, this recalculation may be performed each time a new remote procedure call is issued from a client device.

In some implementations, to further reduce latency, partial results may be returned to the client device as batches of events are filtered. These partial results can include, for example, aggregated UDM fields and the event count timeline. Additionally, the process of applying the snapshot filters may be parallelized. For instance, keys for an in-memory data store, such as a distributed memory object caching system, can be managed to be evenly distributed to facilitate high throughput during parallel processing.

In some implementations, the counts for an event count timeline can be calculated as results are returned from a data source or as results are read from a cache. In some implementations, this can be performed in the same pass in which aggregated UDM fields are calculated and can have similar parallelization characteristics. The event count timeline can also be recalculated when a new set of snapshot filters are applied.

In some implementations, arbitrary sorting of a full resultset may not be allowed to avoid potentially computationally expensive operations. Instead, for a set of most recent events, such as the 10,000 newest events, sorting can be performed on the fly. This sorting process can be parallelized to improve performance.

In some implementations, the security analytics platform may handle scenarios where the same query is executed again before an initial execution is complete. The bookkeeping database may be used to track which time buckets of a query are in-flight or complete. In some implementations, if a cached resultset is not complete for a particular time bucket, the query for that bucket can be re-issued and the corresponding cache entries can be overwritten. In another approach, in-flight queries can be recorded so that subsequent remote procedure calls (RPCs) can wait for the previous queries to complete and then leverage the populated cache. The parallelization and orchestration of these operations may be managed by the security analytics platform.

In some implementations, to manage query performance and system load, a reasonable limit can be enforced on a number of security events returned by a query. This can avoid processing queries that would otherwise surface an excessive number of events, for example, billions of events. To maintain responsiveness, processing of security events can be parallelized. When an event limit for a query is reached, the most recent events within the query's specified time range can be returned.

To enforce such a limit while respecting user-specified time ranges and populating a cache with discrete Query Time Range (QTR) buckets, a system can first determine the number of events within each QTR bucket without reading the event data itself. Based on this determination, the system can structure one or more internal queries with appropriate limits to retrieve the event data. This approach allows the total query limit to be respected, ensures that the most recent events are returned if a limit is hit, and facilitates the use of cached data for subsequent queries.

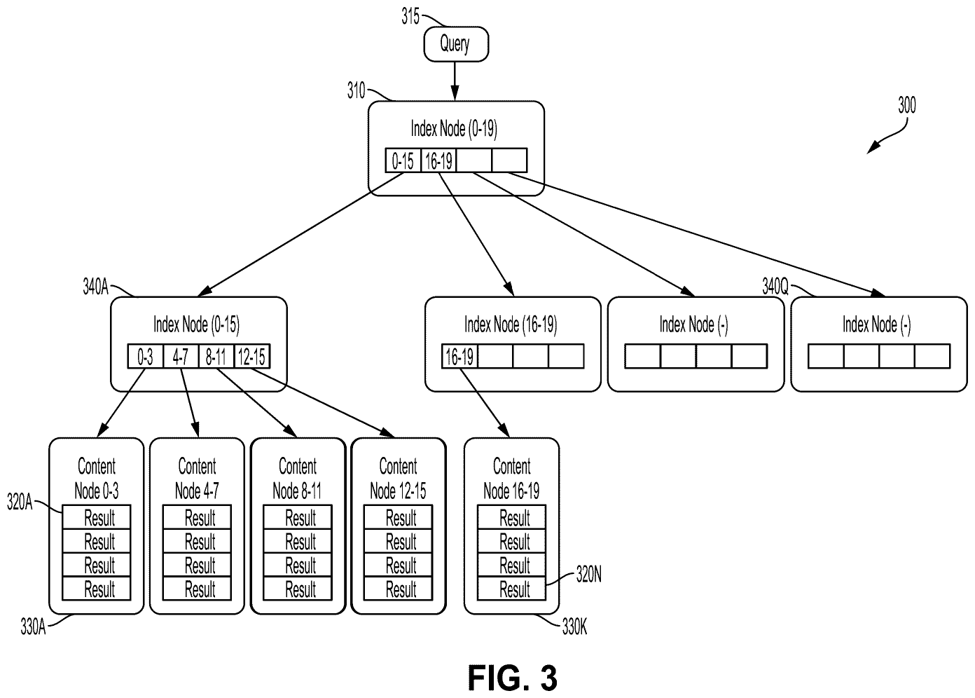

As query results are being received from one or more data sources, these results can be committed to a cache, which can be represented by a distributed memory object caching system. In some implementations, the cache can be organized in accordance with an M-ary tree structure, which is a tree in which each node is allowed to have at most m children, as schematically illustrated by FIG. 3.

FIG. 3 schematically illustrates a distributed memory object caching system implementing an M-ary tree data structure, in accordance with aspects of the present disclosure.

As schematically illustrated by FIG. 3, the M-ary tree 300 can have a single root index node 310, which can be associated (e.g., by a bi-directional or a unidirectional pointer) with a query 315 whose resultsets 320A-320N are cached by the content nodes 330A-330K identified by the index node 310 and its descendent index nodes 340A-340Q. In some implementations, the root index node 310 may store a hash of the query.

As query resultsets 320A-320N, each having a respective unique identifier (ID), are written to content nodes 330A-330K, the IDs of the resultsets and the time ranges covered by the resultsets, are inserted into the closest index node 340. Upon writing a resultset to a content node and inserting its ID and the time range into the closest index node, the upper time limit, which is stored by each of the ancestor index nodes (e.g., index nodes 340A and 310 in the example of FIG. 3), may be updated to correspond to the end of the time range of that result set.

In some implementations, as future results may appear chronologically after existing results, a new root index node can be created, and descendent index nodes can be added to the new root index node, thus expanding the tree with a consistent height.

If all index nodes are full, a new root index node can be created and associated with query. The first entry in the new root index node can point to the previous root index node. The new root index node can then be filled with descendant index nodes to the same height as the previous root index node. This tree design can facilitate pagination, as finding arbitrary time ranges through tree descent may be computationally inexpensive.

In some implementations, to flatten the tree structure, a consistent algorithm for creating keys associated with the resultsets may be used instead of generating them randomly. For example, a key may be formed by combining a hash of the query and time range, a deterministic bucket size, and a content node index. A lookup of the hash of the query and time range can return a single directory node containing multiple buckets, where each bucket represents a slice of the time range for the query. The value for each bucket can be a number of content nodes generated for that time slice. Based on the directory node, a key for a specific content node can be constructed.

As noted herein above, the user interface can use a single streaming remote procedure call (RPC) for the search functionality. The RPC can specify a snapshot query and options for various user interface components, such as options for an event list, options for an event count timeline, and options for Unified Data Model (UDM) field aggregation.

To manage scenarios where a query is executed again before an initial execution is complete, or where a filter is applied to a query that is still processing, a system may use a bookkeeping table to track which time buckets of a query are in-flight or complete. In some implementations, if a time bucket is not fully cached, the query for that bucket can be re-issued, and corresponding cache blocks can be overwritten. In another approach, in-flight queries can be recorded, allowing subsequent RPCs to wait for a previous query to complete before leveraging the populated cache.

In some implementations, to provide updated information for follow-up RPCs, a last aggregated state transmitted to a user interface can be stored. This stored state can be used by future RPCs for the same query. In another approach, a change notification system can be implemented. Subsequent RPCs can subscribe to this system to receive notifications when new data, such as new content nodes, becomes available for a query, allowing the follow-up RPCs to consume new events and update the user interface.

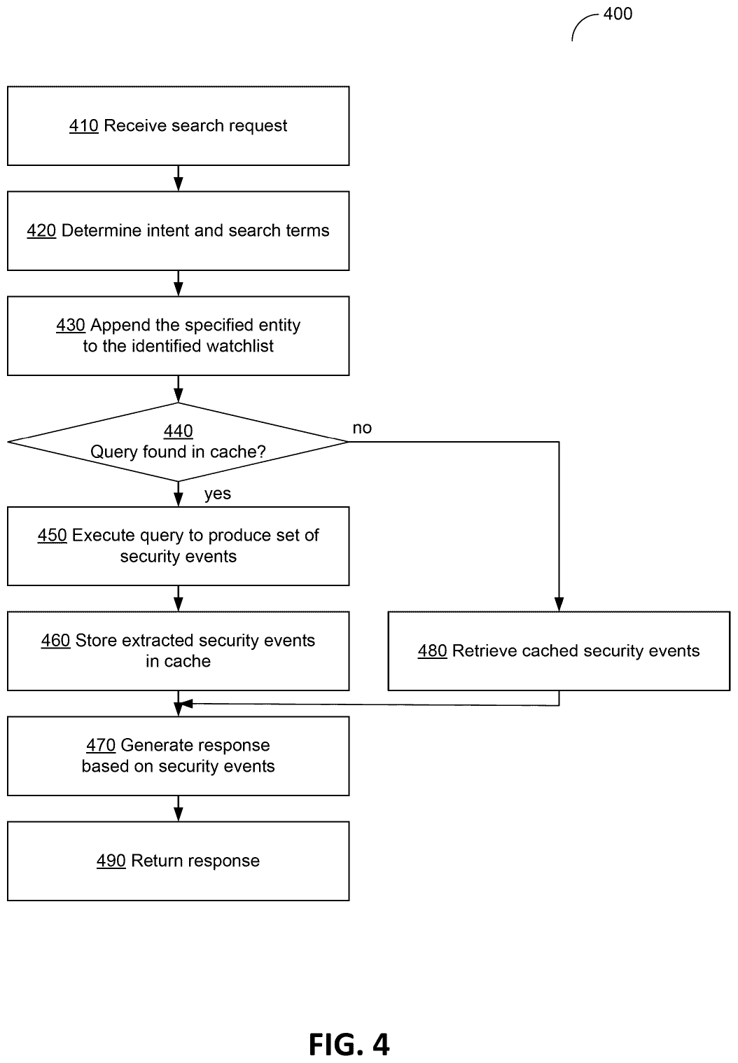

FIG. 4 is a high-level flow diagram of an example method 400 for implementing an interactive search in a security analytics platform operating in accordance with aspects of the present disclosure. The method 400 may be performed by processing logic that may include hardware (e.g., general purpose or specialized processing devices, circuitry, dedicated logic, programmable logic, microcode, integrated circuits, etc.), software (e.g., instructions run or executed on a processing device), or various combinations thereof. In some implementations, method 400 may be performed by a single processing thread. Alternatively, method 400 may be performed by two or more processing threads, each thread executing one or more individual functions, routines, subroutines, or operations of the method. In an illustrative example, the processing threads implementing method 400 may be synchronized (e.g., using semaphores, critical sections, and/or other thread synchronization mechanisms). Alternatively, the processing threads implementing method 400 may be executed asynchronously with respect to each other. In some implementations, the method 400 is performed by a security analytics platform (e.g., platform 120 of FIG. 1). At least some of the operations of method 400 may be performed by the server computing device (e.g., server 130-140 of FIG. 1). Operations of the method 400 may be specified by a sequence of command codes, which the processing logic may retrieve from a dedicated storage location. Although shown in a particular sequence or order, unless otherwise specified, the order of the operations may be modified. Thus, the illustrated implementations should be understood only as examples, and the illustrated operations may be performed in a different order, and some operations may be performed in parallel. Additionally, one or more operations may be omitted in various implementations. Thus, not all operations are required in every implementation.

At operation 410, one or more processing devices implementing the method receive, a search request in a natural language. The request may be received via a user interface, which may be represented by a graphical user interface (GUI) presented on a client device or an application programming interface (API) exposed by the security analytics platform and accessed by a client device, as described in more detail herein above.

At operation 420, the processing devices determine an intent of the request and one or more search terms defining the search request. In some implementations, the intent of the search request can be determined by analyzing the search request, e.g., by an AI-based model. Alternatively, the intent of the search request can be determined by analyzing the search request, e.g., by a set of classifiers (e.g., implemented by neural networks), such that each classifier yields a degree of association of the request with a predefined category of intent. Defining the search terms of the request may involve analyzing the request by AI-based models, classifiers, named entity recognition models, etc. In some implementations, the search terms may include a time range for limiting the search to the security events whose timestamps fall within the time range, as described in more detail herein above.

At operation 430, the processing devices compile a query based on the intent of the search request and the search terms of the search request. In some implementations, the security analytics platform can utilize a set of templates and processing logic (e.g., a rule-based logic and/or an AI-based model) to form a structured query corresponding to the search request, as described in more detail herein above.

At operation 440, the one or more processing devices determine whether the query is cached in a search cache. This determination can involve computing a hash of the structured query and comparing it to hashes of queries stored in the search cache, as described in more detail herein above.

Responsive to determining, at operation 440, that the query is not cached in the search cache, the method proceeds to operation 450. Otherwise, if the query is cached, the method can proceed to operation 480 to retrieve the cached security events, as described in more detail herein above.

At operation 450, which is performed responsive to determining that the query is not cached in the search cache, the processing devices extracting a set of security events by executing the search query against one or more data sources. The data sources can include analytics databases, log databases, telemetry data stores, threat intelligence databases, and/or other security-related information sources, as described in more detail herein above.

At operation 460, the one or more processing devices store the extracted security events in the search cache. Storing the events allows for faster retrieval if the same or a similar query is executed in the future. The events can be stored in association with an identifier of the compiled query and the time range, as described in more detail herein above.

At operation 470, the one or more processing devices generate a response to the search request by processing the plurality of security events. This can involve filtering, aggregating, and correlating the security events with other information extracted from the data sources. For example, the security events can be correlated with threat intelligence data or anomaly detection signals, as described in more detail herein above.

At operation 490, the one or more processing devices return the response, e.g., via the user interface. The response can be presented as a ranked list of results, a timeline, or other visualizations to the user. In some implementations, partial results can be streamed to the user interface while the full query is still processing, as described in more detail herein above.

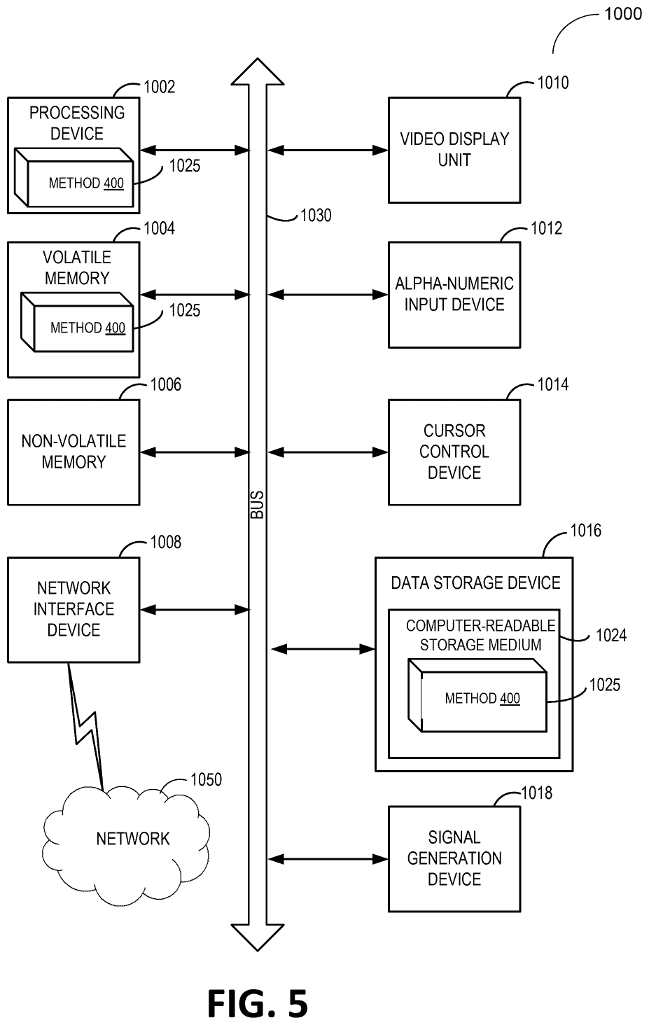

FIG. 5 is a block diagram illustrating an example of a computer system 1000, according to aspects of the disclosure. The computer system 1000 can correspond to security analytics platform 120 and/or client devices 102A-N, described in FIG. 1. Computer system 1000 can operate in the capacity of a server or an endpoint machine in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 1000 includes a processing device 1002 (e.g., a processor), a main memory 1004 (e.g., read-only memory (ROM), flash memory, dynamic random access memory (DRAM) such as synchronous DRAM (SDRAM), double data rate (DDR) SDRAM, or DRAM (RDRAM), etc.), a non-volatile memory 1006 (e.g., flash memory, static random access memory (SRAM), etc.), and a data storage device 1016, which communicate with each other via a bus 1030. In some implementations, the main memory 1004 can be a non-transitory computer readable storage medium.

Processing device 1002 represents one or more general-purpose processing devices such as a microprocessor, central processing unit, or the like. More specifically, processing device 1002 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1002 can also be one or more special-purpose processing devices such as an application specific integrated circuit (ASIC), a field programmable gate array (FPGA), a digital signal processor (DSP), network processor, or the like. The processing device 1002 is configured to execute network interface device 1008 (e.g., for synchronizing data between platforms) for performing the operations discussed herein. The processing device 1002 can be configured to execute instructions 1025 stored in main memory 1004. Non-volatile memory 1006 can store the instructions 1025 when they are not being executed, and can store additional system data that can be accessed by processing device 1002.

The computer system 1000 can further include a network interface device 1008. The computer system 1000 also can include a video display unit 1010 (e.g., a liquid crystal display (LCD) or a cathode ray tube (CRT)), an input device 1012 (e.g., a keyboard, and alphanumeric keyboard, a motion sensing input device, touch screen), a cursor control device 1014 (e.g., a mouse), and a signal generation device 1018 (e.g., a speaker).

The data storage device 1016 can include a computer-readable storage medium 1024 (e.g., a non-transitory machine-readable storage medium) on which is stored one or more sets of instructions 1025 (e.g., instructions implementing method 400 for an interactive search in a security analytics platform) embodying any one or more of the methodologies or functions described herein (e.g., the interactive search engine 141). The instructions can also reside, completely or at least partially, within the main memory 1004 and/or within the processing device 1002 during execution thereof by the computer system 1000, the main memory 1004 and the processing device 1002 also constituting machine-readable storage media. The instructions can further be transmitted or received over a network 1050 via the network interface device 1008.

While the computer-readable storage medium 1024 (machine-readable storage medium) is illustrated in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding, or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one implementation,” “an implementation,” or “an implementation,” means that a specific feature, structure, or characteristic described in connection with the implementation and/or implementation is included in at least one implementation and/or implementation. Thus, the appearances of the phrase “in one implementation,” or “in an implementation,” in various places throughout this specification can, but are not necessarily, referring to the same implementation, depending on the circumstances. Furthermore, the specific features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specific by the execution of software thereon that enables hardware to perform specific functions (e.g., generating interest points and/or descriptors); software on a computer readable medium; or a combination thereof.

The aforementioned systems, circuits, modules, and so on have been described with respect to interactions between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

What is claimed is:

1. A method comprising:
receiving, by one or more processing devices of a security analytics platform, a search request in a natural language;
determining an intent of the search request and one or more search terms defining the search request;
compiling a search query based on the intent of the search request and the one or more search terms defining the search request;
determining whether the search query is cached in a search cache;
responsive to determining that the search query is not cached in the search cache, extracting a plurality of security events by executing the search query against one or more data sources;
storing the extracted security events in the search cache;
generating a response to the search request by processing the plurality of security events; and
returning the response.

2. The method of claim 1, wherein the plurality of security events comprises a plurality of security events.

3. The method of claim 1, wherein the one or more data sources comprise at least one of a log database or a telemetry data store.

4. The method of claim 1, wherein storing the extracted security events in the search cache comprises storing the extracted security events in association with a hash of the search query.

5. The method of claim 1, wherein determining whether the search query is cached comprises:
computing the hash of the search query; and
comparing the computed hash of the search query to each stored hash of a plurality of stored hashes, wherein each stored hash is associated with a corresponding cached set of security events extracted by a corresponding search query.

6. The method of claim 1, wherein the search request further comprises a time range, and wherein determining whether the search query is cached is further based on the time range.

7. The method of claim 1, wherein generating the response further comprises:
correlating the plurality of security events with threat intelligence data.

8. The method of claim 1, wherein generating the response further comprises:
correlating the plurality of security events with one or more anomaly detection signals.

9. The method of claim 1, wherein generating the response further comprises:
ranking the plurality of security events based on relevance.

10. The method of claim 1, wherein returning the response comprises:
streaming one or more partial results to a user interface while the response is being generated.

11. The method of claim 1, wherein the response comprises a distribution of event counts over a timeline.

12. A system comprising:
a memory; and
one or more processing devices coupled with the memory, the one or more processing devices to perform operations comprising:
receiving, by one or more processing devices of a security analytics platform, a search request in a natural language;
determining an intent of the search request and one or more search terms defining the search request;
compiling a search query based on the intent of the search request and the one or more search terms defining the search request;
determining whether the search query is cached in a search cache;
responsive to determining that the search query is not cached in the search cache, extracting a plurality of security events by executing the search query against one or more data sources;
storing the extracted security events in the search cache;
generating a response to the search request by processing the plurality of security events; and
returning the response.

13. The system of claim 12, wherein storing the extracted security events in the search cache comprises storing the extracted security events in association with a hash of the search query.

14. The system of claim 12, wherein determining whether the search query is cached comprises:
computing the hash of the search query; and
comparing the computed hash of the search query to each stored hash of a plurality of stored hashes, wherein each stored hash is associated with a corresponding cached set of security events extracted by a corresponding search query.

15. The system of claim 12, wherein the search request further comprises a time range, and wherein determining whether the search query is cached is further based on the time range.

16. The system of claim 12, wherein returning the response comprises:
streaming one or more partial results to a user interface while the response is being generated.

17. A non-transitory computer readable storage medium comprising instructions for a server that, when executed by one or more processing devices, cause the one or more processing devices to perform operations comprising:
receiving, by one or more processing devices of a security analytics platform, a search request in a natural language;
determining an intent of the search request and one or more search terms defining the search request;
compiling a search query based on the intent of the search request and the one or more search terms defining the search request;
determining whether the search query is cached in a search cache;
responsive to determining that the search query is not cached in the search cache, extracting a plurality of security events by executing the search query against one or more data sources;
storing the extracted security events in the search cache;
generating a response to the search request by processing the plurality of security events; and
returning the response.

18. The non-transitory computer readable storage medium of claim 17, wherein storing the extracted security events in the search cache comprises storing the extracted security events in association with a hash of the search query.

19. The non-transitory computer readable storage medium of claim 17, wherein determining whether the search query is cached comprises:
computing the hash of the search query; and
comparing the computed hash of the search query to each stored hash of a plurality of stored hashes, wherein each stored hash is associated with a corresponding cached set of security events extracted by a corresponding search query.

20. The non-transitory computer readable storage medium of claim 17, wherein returning the response comprises:
streaming one or more partial results to a user interface while the response is being generated.
